(19) United States
(12) Patent Application Publication
(10) Pub. No.: US 2026/0203032 A1
(43) Pub. Date: Jul. 16, 2026

(54) CLOUD-ORIENTED PROGRAMMING PLATFORM

(71) Applicant: Monada EBS LTD, Tel Aviv-Yafo (IL)

(72) Inventors: Elad BEN-SADEH, Tel Aviv (IL); Yoav STEINBERG, Hanita (IL); Christopher RYBICKI, New York, NY (US); Shai BER, Tel Aviv (IL); Eyal KEREN, Tel Aviv (IL); Mark MCCULLOH, Orlando, FL (US)

(73) Assignee: Monada EBS LTD, Tel Aviv-Yafo (IL)

(21) Appl. No.: 19/448,450

(22) Filed: Jan. 14, 2026

Related U.S. Application Data
(60) Provisional application No. 63/745,617, filed on Jan. 15, 2025.

(51) Int. Cl. G06F 8/41

(52) U.S. Cl. CPC G06F 8/433; G06F 8/447

(57) ABSTRACT

A system and method for compiling code. A method includes analyzing portions of code in order to determine potential values using a reaching definitions data flow analysis. Runtime calls to a set of first software infrastructure components are identified based on the potential values. Lift qualification data is generated based on the runtime calls. The lift qualification data includes a method name and a set of rules, where the method name corresponds to a method which is configured to translate an indicator of one of the first software infrastructure components to an indicator of one of a corresponding second software component which is defined at runtime. The set of rules defines configuration parameters and permissions to be used for applying the runtime calls to the first software infrastructure components. A second set of code is compiled based on the lift qualification data.

### CROSS-REFERENCE TO RELATED APPLICATIONS

This application claims the benefit of U.S. Provisional Application No. 63/745,617 filed on Jan. 15, 2025, the contents of which are hereby incorporated by reference.

### TECHNICAL FIELD

The present disclosure relates generally to cloud-oriented programming, and more specifically to managing code deployed in cloud computing environments.

### BACKGROUND

Cloud computing generally refers to the on-demand availability of computing resources over the Internet or otherwise at a remote location accessed via one or more networks. Cloud computing models allow users to access and utilize computing resources remotely without requiring active management or ownership of the physical infrastructure used to implement these computing resources.

Cloud computing has become a common solution for running many kinds of applications. However, cloud computing implementations introduce new challenges. In particular, writing applications to be deployed in the cloud often requires understanding specific details of cloud services, and cloud-based applications to be deployed in the cloud are difficult to effectively test locally.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for compiling code. The method comprises: analyzing at least one portion of code among a first set of code in order to determine a plurality of potential values for each of the at least one portion of code, wherein analyzing the at least one portion of code further comprises performing a reaching definitions data flow analysis on the at least one portion of code; identifying a plurality of runtime calls to a plurality of first software infrastructure components in the first set of code based on the determined plurality of potential values for each of the at least one portion of code, wherein each runtime call of the plurality of runtime calls is to be made at runtime; generating lift qualification data based on the plurality of runtime calls to the plurality of first software infrastructure components, wherein the set of lift qualification data includes a method name and a set of rules, wherein the method name corresponds to a method which is configured to translate an indicator of a first software infrastructure component among the plurality of first software components to an indicator of a second software infrastructure component of a plurality of second software components, wherein each second software component is defined at runtime and corresponds to one of the plurality of first software components, wherein the set of rules defines configuration parameters and permissions to be used for applying the plurality of runtime calls to the plurality of first software infrastructure components; and compiling a second set of code based on the lift qualification data.

Certain embodiments disclosed herein also include a non-transitory computer readable medium having stored thereon causing a processing circuitry to execute a process, the process comprising: analyzing at least one portion of code among a first set of code in order to determine a plurality of potential values for each of the at least one portion of code, wherein analyzing the at least one portion of code further comprises performing a reaching definitions data flow analysis on the at least one portion of code; identifying a plurality of runtime calls to a plurality of first software infrastructure components in the first set of code based on the determined plurality of potential values for each of the at least one portion of code, wherein each runtime call of the plurality of runtime calls is to be made at runtime; generating lift qualification data based on the plurality of runtime calls to the plurality of first software infrastructure components, wherein the set of lift qualification data includes a method name and a set of rules, wherein the method name corresponds to a method which is configured to translate an indicator of a first software infrastructure component among the plurality of first software components to an indicator of a second software infrastructure component of a plurality of second software components, wherein each second software component is defined at runtime and corresponds to one of the plurality of first software components, wherein the set of rules defines configuration parameters and permissions to be used for applying the plurality of runtime calls to the plurality of first software infrastructure components; and compiling a second set of code based on the lift qualification data.

Certain embodiments disclosed herein also include a system for compiling code. The system comprises: a processing circuitry; and a memory, the memory containing instructions that, when executed by the processing circuitry, configure the system to: analyze at least one portion of code among a first set of code in order to determine a plurality of potential values for each of the at least one portion of code, wherein analyzing the at least one portion of code further comprises performing a reaching definitions data flow analysis on the at least one portion of code; identify a plurality of runtime calls to a plurality of first software infrastructure components in the first set of code based on the determined plurality of potential values for each of the at least one portion of code, wherein each runtime call of the plurality of runtime calls is to be made at runtime; generate lift qualification data based on the plurality of runtime calls to the plurality of first software infrastructure components, wherein the set of lift qualification data includes a method name and a set of rules, wherein the method name corresponds to a method which is configured to translate an indicator of a first software infrastructure component among the plurality of first software components to an indicator of a second software infrastructure component of a plurality of second software components, wherein each second software component is defined at runtime and corresponds to one of the plurality of first software components, wherein the set of rules defines configuration parameters and permissions to be used for applying the plurality of runtime calls to the plurality of first software infrastructure components; and compile a second set of code based on the lift qualification data.

Certain embodiments disclosed herein include the method, non-transitory computer readable medium, or system noted above or below, further including or being configured to perform the following step or steps: generating a set of lift instructions based on the lift qualification data, wherein the set of lift instructions, when executed by a system while compiling the second set of code, configures the system to execute the method corresponding to the method name indicated in the set of lift qualification data.

Certain embodiments disclosed herein include the method, non-transitory computer readable medium, or system noted above or below, wherein each first software component and the corresponding second software component are both assigned a shared identifier of a plurality of shared identifiers, wherein the lift qualification data is generated based on the plurality of shared identifiers.

Certain embodiments disclosed herein include the method, non-transitory computer readable medium, or system noted above or below, further including or being configured to perform the following step or steps: aggregating at least a portion of the plurality of calls based on a plurality of references in the first set of code to the plurality of first software infrastructure components and the plurality of shared identifiers, wherein the lift qualification data is generated based further on the aggregation.

Certain embodiments disclosed herein include the method, non-transitory computer readable medium, or system noted above or below, further including or being configured to perform the following step or steps: assigning at least one first application programming interface (API) to each of the plurality of first software infrastructure components, wherein each first API is utilized to configure at least a portion of a software infrastructure; and assigning at least one second API to each of the plurality of second software infrastructure components, wherein each second API is utilized to access at least one resource at runtime, wherein the lift qualification data is generated based on the at least one first API assigned to each of the plurality of first software infrastructure components and the at least one second API to each of the plurality of first software infrastructure components.

Certain embodiments disclosed herein include the method, non-transitory computer readable medium, or system noted above or below, further including or being configured to perform the following step or steps: determining a plurality of expressions which evaluate to first software infrastructure components of the plurality of first software infrastructure components, wherein the plurality of runtime calls to the plurality of first software infrastructure components is identified based on the determined plurality of expressions.

Certain embodiments disclosed herein include the method, non-transitory computer readable medium, or system noted above or below, further including or being configured to perform the following step or steps: iteratively checking potential values of the plurality of potential values for each of the plurality of runtime calls, wherein the potential values are iteratively checked for each runtime call until all potential values for the runtime call evaluate to one of the plurality of first software infrastructure components.

Certain embodiments disclosed herein include the method, non-transitory computer readable medium, or system noted above or below, further including or being configured to perform the following step or steps: selecting a target language based on a computing environment in which the second set of code is to be deployed, wherein the second set of code is compiled based on the target language.

Certain embodiments disclosed herein include the method, non-transitory computer readable medium, or system noted above or below, further including or being configured to perform the following step or steps: identifying at least one phase-independent portion of code among the first set of code, wherein each phase-independent portion of code lacks reference to any of the plurality of first software infrastructure components, wherein the lift qualification data is generated based further on the identified at least one phase-independent portion of code.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIGS. 1A-B are network diagrams utilized to describe various disclosed embodiments.

FIG. 2 is a flowchart illustrating a method for managing code according to an embodiment.

FIG. 3 is a flowchart illustrating a method for lifting code according to an embodiment.

FIG. 4 is a flowchart illustrating a method for compiling code according to an embodiment.

FIG. 5 is a flowchart illustrating a method for executing in-flight code according to an embodiment.

FIG. 6 is a schematic diagram of a code manager according to an embodiment.

FIG. 7 is a schematic diagram of a cloud server according to an embodiment.

### DETAILED DESCRIPTION

The disclosed embodiments include a cloud-oriented programming platform and techniques for managing code in cloud-oriented programming environments. To this end, various disclosed embodiments include techniques for compiling code in order to realize cloud-oriented programming via dependency injection and configuration definition which enable lifting pre-flight code for in-flight execution. More specifically, code is compiled such that the compiled code, when executed by a system, causes the executing system to perform in-flight operations using references and permissions for pre-flight objects or other pre-flight infrastructure components. The in-flight operations are defined by in-flight portions of code which are intended to be performed at runtime during execution of an application or other software running the code. The pre-flight infrastructure components are realized via pre-flight portions of code which define objects or other components to make up at least a portion of a computing infrastructure.

Various disclosed embodiments include techniques for lifting code in order to enable connecting in-flight code expressions (for example, expressions among code to be executed at runtime) to pre-flight infrastructure components (for example, components defined prior to runtime using pre-flight code). To this end, in various embodiments, in-flight expressions which evaluate to pre-flight infrastructure components are identified, and lift qualification data used for lifting those in-flight expressions is generated. The lift qualification data may include, but is not limited to, a method name and a set of rules to be used for enabling the in-flight expressions to be used with respect to pre-flight infrastructure components. The set of rules, in turn, may be used to compile the code with configuration parameters and permissions to be utilized for applying the in-flight expressions to the pre-flight infrastructure components.

To support the pre-flight and in-flight activities of the pre-flight and in-flight code, various versions of the process further include assigning respective sets of application programming interfaces (APIs) to pre-flight and in-flight objects created as a result of the pre-flight and in-flight code. That is, a set of pre-flight APIs is assigned to each pre-flight object, and a set of in-flight APIs is assigned to each in-flight object. Moreover, each pre-flight object represented in the pre-flight code may be generated based on the pre-flight code, and a corresponding in-flight object is generated based on each in-flight object. Respective APIs may be assigned to each object in order to enable the object to perform relevant functions for pre-flight or in-flight activities.

By creating an in-flight version of each pre-flight object, these objects may be assigned the respective APIs used to perform their respective pre-flight and in-flight functions while allowing for associating the in-flight and pre-flight versions of the object during code compiling. Consequently, the compiled code may be used to enable in-flight expressions to be properly resolved to pre-flight infrastructure components, for example by associating pre-flight expressions and in-flight expressions which correspond to pre-flight and in-flight versions of a given infrastructure component. More specifically, each pre-flight component and the corresponding in-flight component may both be assigned the same identifier such that a reference to that identifier acts as a reference to both the pre-flight and in-flight versions of the infrastructure component. This effectively allows for creating versions of infrastructure components which may be interacted with at runtime.

The disclosed embodiments further include techniques for data flow analysis which may be utilized to generate lift instructions to be used during compiling to lift pre-flight infrastructure components. Calls to in-flight operations which are performed on pre-flight object types are identified, and the in-flight code corresponding to those identified calls is analyzed in order to determine potential values of the pre-flight object at locations of the identified calls. More specifically, potential values may be iteratively checked until a known pre-flight expression is determined for each of the pre-flight objects referenced in the identified calls. The pre-flight expression determined for each of the pre-flight objects may be used to determine a corresponding in-flight expression of an in-flight object, which in turn may be used to generate the qualification data in order to effectively allow the in-flight code to act upon the pre-flight infrastructure components. The identified calls may further be aggregated, for example based on the pre-flight object references in each identified call, and the qualification data may be further generated based on the aggregated calls.

Various embodiments described herein may further utilize flight-agnostic code which lacks reference to any infrastructure components. Because code lacking reference to any infrastructure components does not require resolving between in-flight expressions and pre-flight infrastructure components, the lifting process as discussed in this application may be avoided for portions of the code which are determined to be flight-agnostic. That is, any portions of code which are determined to be flight-agnostic may be executed as is or otherwise without adapting any components references in the code to have both pre-flight and in-flight versions as discussed in this application. Accordingly, compiling flight-agnostic code as is allows for conserving computing resources related to performing a lifting process with respect to the flight-agnostic code.

Various embodiments described herein further include techniques for generating in-flight clients to be utilized for infrastructure representations. The in-flight clients may be or may include libraries to be used in-flight. More specifically, the libraries may be defined with respect to computing resources (for example, a database and cache) indicated in the pre-flight code. When the libraries are incorporated into code during compiling, the code contains instructions that, when executed by a system, configure the executing system to configure a system setup in order to allow the system to access the computing resources at runtime (in-flight). The computing resources, in turn, may include an infrastructure representation library and one or more functions (for example, a dependency injection function) which may be utilized to realize appropriate infrastructure definitions and selecting an appropriate type of code for a target computing environment in which the code is to be deployed.

In this regard, it is noted that cloud computing environments utilize both functional code utilized to perform functions with respect to a computing infrastructure as well as infrastructure-side or other non-functional code utilize to define or otherwise establish the infrastructure. Both of these types of code (functional and infrastructure-side/non-functional) may therefore reference infrastructure components. However, differences in how the infrastructure components are expressed between infrastructure-side code and functional code may result in at least some of the code failing to execute properly.

Some solutions for avoiding such differences may include passing identities of infrastructure components via variables. However, these solutions involve passing a large amount of data through variables (which may increase the amount of computing resources needed to execute code). Additionally, these solutions may require manually checking permissions and network topologies in order to ensure that code is properly defined to ensure that the variables pass the correct infrastructure component data to the correct locations.

The various disclosed embodiments therefore allow for automatically and accurately referencing infrastructure components between functional and infrastructure-side code. Such references may be realized using code added during compiling without requiring explicitly passing variables between pre-flight and in-flight portions of the code. Additionally, various disclosed embodiments may allow for automatically compiling code into a language of a target environment in which the code is to be deployed.

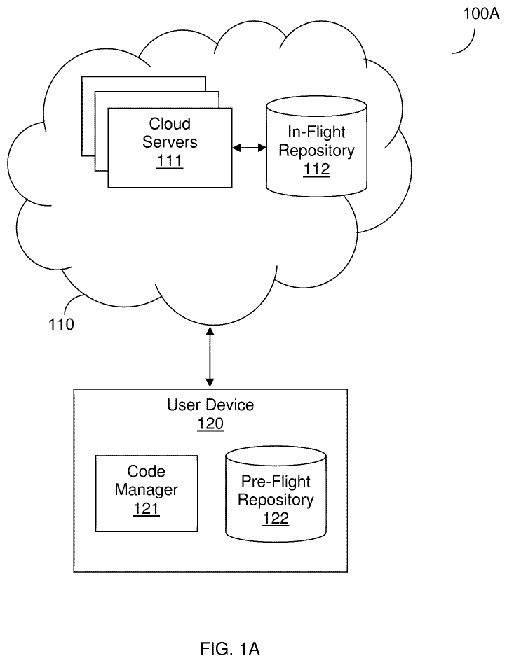

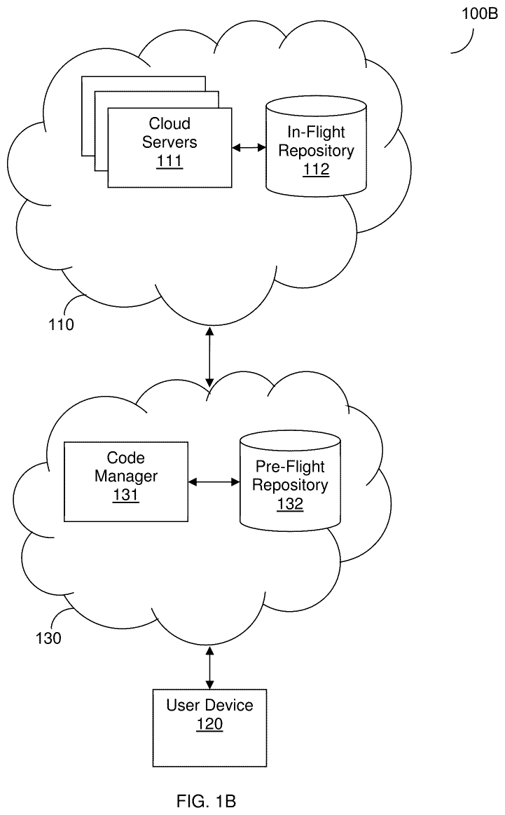

FIGS. 1A-B are network diagrams 100A and 100B, respectively, utilized to describe various disclosed embodiments.

As shown in FIG. 1A, a cloud computing environment 110 communicates with a user device 120.

The cloud computing environment 110 may be realized via one or more networks (not separately depicted). Such networks may be or may include, but are not limited to, a wireless, cellular or wired network, a local area network (LAN), a wide area network (WAN), a metro area network (MAN), the Internet, the worldwide web (WWW), similar networks, and any combination thereof. Such networks may be networks used to make up the cloud computing environment, networks through which systems among the cloud computing environment communicate with systems outside the cloud computing environment (for example, the user device 120), both and the like.

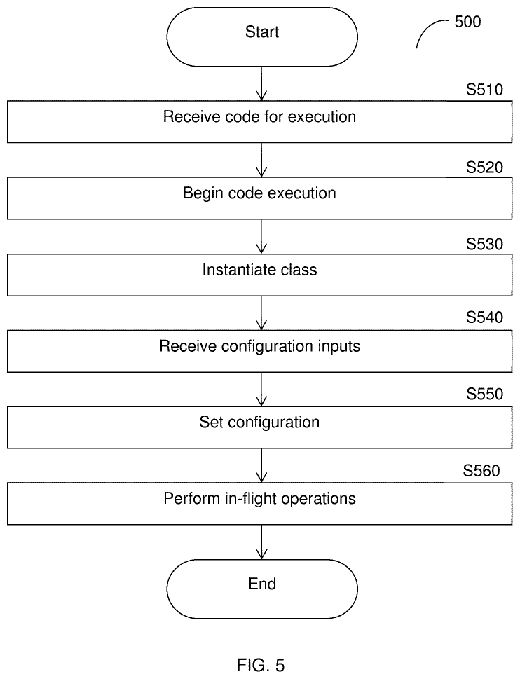

As depicted in FIG. 1A, the cloud computing environment 110 includes one or more cloud servers 111 and an in-flight repository 112. The cloud servers 111 may be utilized, for example, in order to execute code of cloud-based applications to be deployed in the cloud via the cloud computing environment 110. An example process which may be performed by the cloud servers 111 is described further below with respect to FIG. 5. As discussed herein, the cloud servers 111 may execute in-flight code generated as described herein based on pre-flight code in order to realize the cloud-based applications using the in-flight code. The in-flight code may define software components to instantiate in the cloud computing environment 110, functions related to those software components, data to be used by those components (for example, libraries), and the like. The in-flight repository 112 may store, but is not limited to, such in-flight code.

The user device 120 may be, but is not limited to, a personal computer, a laptop, a tablet computer, a smartphone, a wearable computing device, or any other device capable of receiving user inputs and communicating with the cloud computing environment via one or more networks.

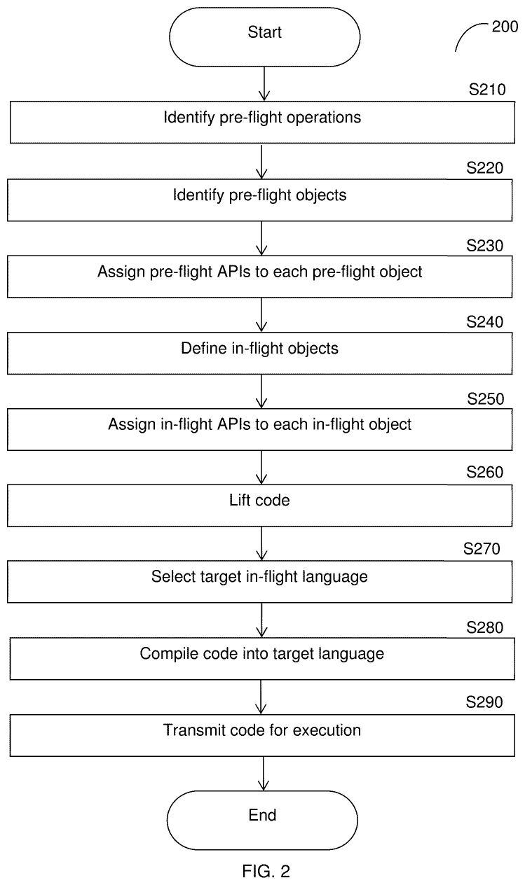

As depicted in FIG. 1A, the user device 120 includes a code manager 121 and a pre-flight repository 122. The code manager 121 may be realized via hardware, software, or a combination of hardware and software. The code manager 121 may be configured to generate in-flight code and to manage pre-flight and in-flight code as discussed herein, for example as described further below with respect to FIGS. 2-4. The pre-flight repository 122 may store pre-flight code, and may also store in-flight code (for example, in-flight code to be deployed via the computing environment 110).

FIG. 1B depicts an alternative implementation in which the cloud computing environment 110 is a first computing environment and a code manager 131 configured to manage pre-flight and in-flight code as discussed herein is deployed in a second computing environment 130. As a non-limiting example, the computing environment 130 may be owned or operated by a third party service provider who providers servers to run the code manager 131 and which provide services including code management as discussed herein. In such an implementation, a pre-flight repository 132 may be deployed in the computing environment 130.

FIG. 2 is a flowchart 200 illustrating a method for managing code according to an embodiment. In an embodiment, the method is performed by a code manager such as the code manager 121 or the code manager 131, FIGS. 1A-B.

At S210, one or more pre-flight operations are identified in a set of code. The set of code may include various portions where at least some portions of the code may be pre-flight code to be executed prior to runtime and other portions of the code may be in-flight code to be executed at runtime. The pre-flight portions of code may be utilized to define an infrastructure state including, but not limited to, software infrastructure components such as objects among the infrastructure. The in-flight portions of code may contain application logic that interacts with or otherwise references the software infrastructure components at runtime.

In an embodiment, the pre-flight operations are identified based on one or more lines of code including definitions of software infrastructure components such as objects. To this end, in a further embodiment, identifying the pre-flight operations may include analyzing the code in order to identify one or more predetermined method names known to be used for defining infrastructure components, predetermined structures of methods known to be associated with defining or otherwise creating infrastructure components, combinations thereof, and the like.

Some portions of the code may also be neither pre-flight nor in-flight portions of code, for example, portions of code which lack reference to any infrastructure components. As discussed herein, such portions of code lacking reference to infrastructure components may be identified as phase-independent and processed accordingly. Because such phase-independent portions of code do not relate to infrastructure, the phase-independent portions may be executed as part of either pre-flight activities or post-flight activities without requiring lifting or other modifications. Moreover, the data used for phase-independent operations may be shared among data used for pre-flight and in-flight operations rather than requiring separate sets of data for pre-flight and in-flight activities, thereby allowing for reducing the total amount of data needed for pre-flight activities and in-flight activities.

Such pre-flight portions of code may be executed locally rather than in the cloud or otherwise at a remote computing environment accessible via one or more networks such as the Internet. That is, the pre-flight operations may occur by executing code on one or more local systems (for example, systems which generated the code or systems available over one or more local networks) rather than via remote deployment of code in a computing environment that is accessible via one or more external networks such as, but not limited to, the Internet.

In an embodiment, the pre-flight code defines or otherwise identifies resources such as objects to be deployed in a computing environment (e.g., the cloud computing environment 110, FIGS. 1A-B). That is, the pre-flight code defines objects to be deployed remotely when code is executed in the computing environment. The objects may be, but are not limited to, components of a software infrastructure.

In an embodiment, the pre-flight operations identified at S210 are defined via expressions which evaluate to such pre-flight objects. That is, in such an embodiment, a pre-flight operation is identified based on an expression which evaluates to a pre-flight object. Other portions of the pre-flight code may evaluate to constant values or other constant data instead of objects and, therefore, such portions would not be identified as pre-flight operations.

In an embodiment, identifying the pre-flight operations includes identifying pre-flight expressions within the pre-flight code. The pre-flight expressions may be identified based on one or more pre-flight expression indicators such as, for example but not limited to, predetermined structures, keywords or other predetermined strings, both, and the like. To this end, in a further embodiment, S210 includes analyzing the pre-flight code in order to identify such indicators.

At S220, pre-flight objects are identified based on the code. More specifically, any objects defined in the pre-flight code (for example, defined via the pre-flight operations identified at S210) are identified as pre-flight objects based on their definitions within the pre-flight code.

At S230, one or more pre-flight application programming interfaces (APIs) are assigned to each pre-flight object. In an embodiment, the pre-flight APIs assigned to each pre-flight object include one or more predetermined APIs used for one or more pre-flight activities. Such pre-flight APIs may be among a set of predetermined pre-flight APIs defined in order to enable certain pre-flight activities. In some embodiments, only a subset of potential pre-flight APIs may be assigned to a given pre-flight object. In such an embodiment, assigning the pre-flight APIs to each pre-flight object may include analyzing the pre-flight operation defining the pre-flight object in order to determine applicable pre-flight APIs for the pre-flight object. To this end, in a further embodiment, S230 includes applying a set of API selection rules based on the pre-flight operation used to define each pre-flight object. When the lift instructions are generated, the lift instructions may define configurations including configuring the pre-flight operations to call the respective pre-flight APIs of the applicable pre-flight objects in order to perform pre-flight activities.

At S240, an in-flight object is defined for each pre-flight object. In an embodiment, each in-flight object is identified for a respective pre-flight object such that the in-flight object corresponds to one of the pre-flight objects and acts as an in-flight counterpart to the corresponding pre-flight object. As discussed further herein below, the in-flight objects may be assigned a shared identifier that is shared between the in-flight object and its counterpart pre-flight object in order to facilitate lifting. The lift instructions used to lift the code may include references to these shared identifiers such that the lift instructions effectively connect pre-flight objects referenced by in-flight operations to their in-flight counterparts.

At S250, one or more in-flight APIs are assigned to each in-flight object. In an embodiment, the in-flight APIs assigned to each in-flight object include one or more predetermined APIs used for one or more in-flight activities. Such in-flight activities may be or may include, but are not limited to, runtime activities to be performed during execution. When the lift instructions are generated, the lift instructions may define configurations including configuring the in-flight operations to call the respective in-flight APIs of the applicable in-flight objects in order to perform in-flight activities. The in-flight APIs may be used to access resources needed for in-flight activities such as, but not limited to, certain databases, caches, libraries combinations thereof, and the like.

In some embodiments, only a subset of potential in-flight APIs may be assigned to a given in-flight object. In such an embodiment, assigning the in-flight APIs to each in-flight object may include analyzing the pre-flight operation defining the counterpart pre-flight object in order to determine applicable in-flight APIs for the in-flight object. To this end, in a further embodiment, S230 includes applying a set of API selection rules based on the pre-flight operation used to define each pre-flight object and the relationships between pre-flight objects and their in-flight counterparts.

In this regard, it is noted that the pre-flight objects and in-flight objects may be assigned respective APIs needed to perform certain functions used pre-flight and at runtime in-flight, respectively. Accordingly, assigning APIs for pre-flight and in-flight activities to pre-flight and in-flight objects, respectively, allows each object to effectively serve a given role (pre-flight or in-flight).

At S260, at least a portion of the code is lifted in order to allow relevant portions of the code to be utilized for in-flight activities. In an embodiment, lifting the code includes generating lift qualification data such as, but not limited to, a method name and set of rules to be used during in-flight operations. The result is a set of lifting data which effectively connects expressions in the pre-flight code to expressions which will be included in the in-flight code (for example, when the in-flight code is compiled into a target language).

In an embodiment, the lift qualification data at least includes data used to translate pre-flight objects represented in expressions into their in-flight counterparts. To this end, in a further embodiment, lifting the code may include, but is not limited to, copying at least a portion of data from the code (for example, static data which does not reference an object), calling a lift function configured to translate a pre-flight object into its in-flight counterpart (for example, based on known in-flight objects generated based on respective pre-flight objects), both, and the like.

In this regard, the lifting data including the lift qualification data defines in-flight expressions based on pre-flight expressions and correlations between pre-flight objects and their respective in-flight object counterparts. That is, in at least some embodiments, lifting the code includes lifting expressions in the code such that any expressions indicating pre-flight objects are translated so that they instead indicate the counterpart in-flight objects corresponding to the pre-flight objects indicated in the expressions.

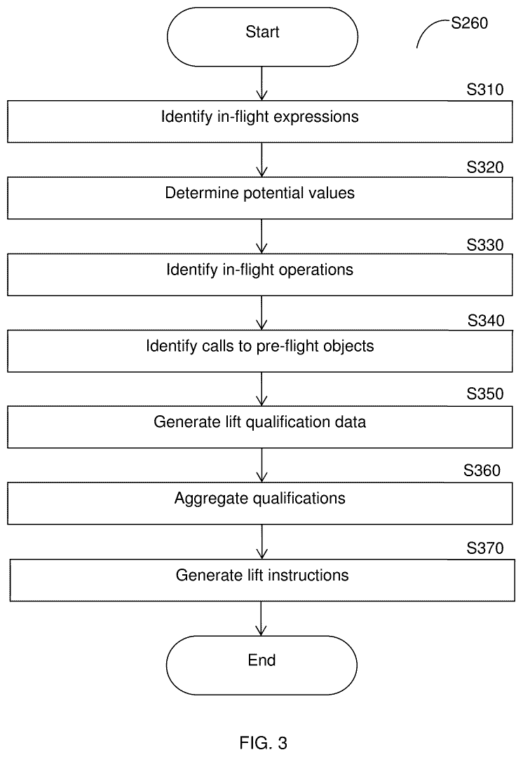

An example process for lifting code which may be utilized at S260 is described further below with respect to FIG. 3.

At S270, a target in-flight language is selected. The target in-flight language is a language used for in-flight code that will be utilized for lifting. That is, the target in-flight language is selected such that lifted portions of the code are in the target language in order to allow the lifted code to be executed at runtime. In an embodiment, the target in-flight language is selected based on a computing environment (for example, a cloud computing environment) in which at least a portion of the code will be executed at runtime. In a further embodiment, the target language is a language used or otherwise recognized by systems deployed in the computing environment.

At S280, the code is compiled into the target in-flight language in order to generate a set of in-flight code. The resulting set of in-flight code, when executed by a system, configures that system to perform in-flight operations using references and permissions for pre-flight objects or other pre-flight infrastructure components defined by or otherwise identified in the corresponding pre-flight code used to generate the data which is compiled into the in-flight code. The in-flight operations are defined by in-flight portions of code which are intended to be performed at runtime during execution of an application or other software running the code.

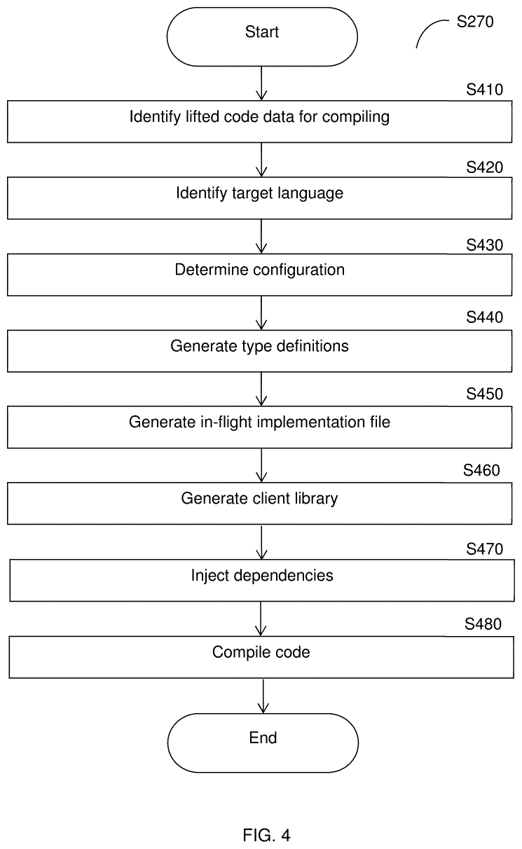

An example process for compiling code which may be utilized at S270 is described further below with respect to FIG. 4.

At S290, the set of in-flight code is transmitted for execution. In an embodiment, the set of in-flight code is transmitted to one or more external systems (for example, systems deployed in a cloud computing environment) over one or more networks in order to be executed remotely.

FIG. 3 is a flowchart S260 illustrating a method for lifting code according to an embodiment.

At S310, one or more in-flight expressions are identified in a set of code. In an embodiment, the set of code is a pre-flight set of code used for defining resources to be deployed in a computing environment (e.g., a cloud computing environment) or otherwise for pre-flight activities. The in-flight expressions may be identified, for example, based on one or more predetermined structures, keywords or other strings, or other indicators of in-flight operations which may be represented in the code.

At S320, potential values are analyzed for at least one portion of the code. In an embodiment, potential values may be iteratively checked until a predetermined or otherwise known pre-flight expression is determined for each of the pre-flight objects referenced in the identified calls. More specifically, in a further embodiment, S320 includes statically analyzing the code in order to determine potential values (for example, potential values of objects defined in portions of code). The determined potential values may, in turn, be utilized to determine whether a given expression included in a given portion of code evaluates to a pre-flight object. As discussed further below with respect to S330, expressions in portions of code which evaluate to pre-flight objects may be used to identify in-flight portions of code (for example, in-flight portions of code that reference pre-flight objects such that lifting the code may be required).

As a non-limiting example to illustrate circumstances where potential values may not be needed in order to aid in identifying in-flight portions of code, consider the following first portion of code:
let preflightObject=new PreflightObject(“configuration”);

This first portion of code defines an object as an infrastructure component and therefore acts as pre-flight code including a pre-flight operation used to realize the definition of the object. In this non-limiting example, the code further includes the following second portion of code:
preflightObject.inflightOperation(“parameter”);

This second portion of code references an object (“preflightObject”) defined via a pre-flight portion of code and performs an operation on that object such that the second portion of code acts as in-flight code including the in-flight operation on the object. Moreover, the parameter “parameter” is passed to the operation “inflightOperation” in order to enable “inflightOperation” to be performed with respect to “preflightObject.”

Accordingly, in this non-limiting example, the relationship between the operation “inflightOperation” and the previously defined object “preflightObject” is explicit in the code at rest such that potential values of “inflightOperation” do not need to be determined in order to identify “inflightOperation” as an in-flight expression and the second portion of code as an in-flight portion of code.

It should be noted that, in some cases, a variable or expression referencing a pre-flight object is evaluated in-flight. Likewise, an in-flight operation performed on a pre-flight object, as well as any parameters passed to that operation may be unknown at the time code is compiled. Accordingly, in such cases, potential values may be analyzed in order to aid in identifying in-flight portions of code. To illustrate this situation, consider the following first portion of code as a non-limiting example:
let preflightObject1=new PreflightObject(“some configuration1”);
let preflightObject2=new PreflightObject(“some configuration2”);

This non-limiting example first portion of code defines objects as infrastructure components and therefore acts as pre-flight code. As a further non-limiting example, the set of code including this first portion of code further includes the following second portion of code:
let randomPreflightObj=randomObject([preflightObject1, preflightObject2]);
let randomInflightOp=randomOp([randomPreflightObj.inflightOperation1, randomPreflightObj.inflightOperation2]);
let randomParam=randomText( );
randomInflightOp(randomParam);

Rather than define entirely new objects like the pre-flight first portion of code, the second portion of code defines objects using functions and parameters which might reference existing objects. However, since these connections are not explicit because the operations among the second portion of code are not performed directly on the objects defined in the first portion of code, a direct analysis of which operations are performed on which objects will not allow for identifying the operations among the second portion of code as in-flight operations. By determining potential values of the objects “randomPreflightObj,” “randomInflightOp,” and “randomParam,” it may be determined whether the corresponding line of code defining each of these objects acts as in-flight code which evaluates to one of the pre-flight objects “preflightObject1” or “preflightObject2.”

To determine potential values, in an embodiment, S320 includes performing a static analysis on the code in order to identify variables indicated therein, and analyzing data flows in order to determine the potential values. The determined values may be used during subsequent processing to determine which lift instructions and qualifications to generate for the code. More specifically, the potential values may be utilized to generate the appropriate lift instructions and qualifications during subsequent processing. Certain types of lift instructions and qualifications may correspond to respective values or potential values of variables such that those types of lift instructions may be generated for variables having those values or potential values.

To this end, in a further embodiment, S320 includes performing a reaching definitions data flow analysis in order to map potential values of in-flight expressions that reference pre-flight objects. In such an embodiment, calls to in-flight operations on pre-flight object types may be identified by applying a type checker algorithm defined with respect to structures, strings, or both, associated with known references to pre-flight objects. A reaching definitions analysis may be performed on the portions of code corresponding to the calls to the in-flight operations in order to identify potential values of the referenced pre-flight objects at the locations of those calls.

Such a reaching definitions analysis is a data flow analysis which tracks the definition of a variable or expression and determines points in a program where the definition (for example, an instruction that writes to a variable) reaches a particular use of that variable or expression. In yet a further embodiment, the reaching definitions analysis may be iterated at least until all potential definitions of an in-flight expression referencing a pre-flight object are predetermined pre-flight expressions. Stopping iteration when all potential definitions of an in-flight expression referencing a pre-flight object are predetermined pre-flight expressions allows for correctly identifying the in-flight expressions which reference pre-flight objects to be lifted via qualifications as discussed below while reducing use of computing resources needed for further iterations. That is, once all possible definitions are determined to reference a pre-flight object (even if the specific value of the pre-flight object has not been determined), the expression may be accurately identified as referencing a pre-flight object without continuing iterations of the data flow analysis.

At S330, calls to pre-flight objects by in-flight operations are identified. More specifically, expressions which evaluate to pre-flight infrastructure components are identified. As a non-limiting example, for an expression databases[0].query(“select*from someTable”), a portion of the expression “databases[0]” references some infrastructure (a database) and acts upon that database by reading from a table called “someTable.” As discussed further below, a qualification for this expression may therefore be derived from the in-flight operation “query” and the parameters “select*from someTable.”

In an embodiment, identifying the calls to pre-flight objects includes analyzing the code in order to identify lines of code including operations which are performed on pre-flight objects based on a structure of those lines and pre-flight objects defined in previous lines of the code (for example, objects defined using predetermined methods which are known to generate objects pre-flight). In one of the examples noted above, the line of code “preflightObject.inflightOperation(“parameter”);” may be determined as including a call to a pre-flight object due to a structure of the line of code (“preflightObject” followed by a period “.” followed by “inflightOperation) as well as the information that “preflightObject” is a pre-flight object defined by a predetermined pre-flight operation “let.”

When this relationship is not explicit, identifying the calls to pre-flight objects may include analyzing the potential values determined above in order to determine whether all potential values of a given expression evaluate to pre-flight objects. If all potential values of a given expression evaluate to pre-flight objects, the expression may be identified as including a call to a pre-flight object.

At optional S340, calls among the code may be aggregated. In an embodiment, calls among the code are aggregated based on the pre-flight object references in the code. In a further embodiment, the calls are aggregated based on the identifier of the pre-flight object which is shared with its corresponding in-flight object counterpart. When the resulting aggregated calls are used to compile the in-flight code, the resulting in-flight code may include fewer calls, thereby conserving computing resources.

More specifically, in yet a further embodiment, the lift qualification data generated as discussed below includes qualifications in the form of methods or other portions of code to be used for in-flight operations. Qualifications related to aggregated calls (for example, duplicate instances of methods used on the same targets for different calls among a set of aggregated calls) may be aggregated such that duplicate or otherwise redundant instances of the qualifications may be excluded from the qualification data, thereby reducing the among of qualification data and, consequently, reducing the amount of data to be compiled, thereby conserving computing resources.

In an embodiment, the calls are aggregated based on connections in code. To this end, in an embodiment, calls between methods or other portions of code may be analyzed in order to identify connections between methods, and calls may be aggregated based on these connections. As a non-limiting example where a method A calls a method B and the method B calls a method C, the call from method B to method C and any calls from method C to other methods may be aggregated into the call from method A to method B.

At S350, in-flight operations referenced by the code are identified. The pre-flight expression determined for each of the pre-flight objects may be used to determine a corresponding in-flight expression of an in-flight object. The identification of these in-flight operations may be used to generate the qualification data in order to effectively allow the in-flight code to act upon the pre-flight infrastructure components. In an embodiment, the identified in-flight operations are operations whose expressions include calls to pre-flight objects identified as discussed above with respect to S330.

At S360, lift qualification data is generated. The lift qualification data may include, but is not limited to, a method name of a method configured to translate pre-flight object indicators to in-flight object indicators, a set of rules to be used for enabling the in-flight expressions to be used with respect to pre-flight infrastructure components, code of the method (for example, a block of code including at least a portion of the lift instructions), combinations thereof, and the like.

The set of rules, in turn, may be used to compile the code with configuration parameters and permissions to be utilized for applying the in-flight expressions to the pre-flight infrastructure components. The configuration parameters may further define settings, libraries, caches, data structures, or other data to be used for configuring a computing environment in order to enable certain activities (for example, to perform in-flight activities using certain libraries and caches designated for use by in-flight operations). The libraries may be instantiated by predetermined pre-flight classes when executed at runtime.

In some embodiments, libraries designated for use by in-flight operations may include, but are not limited to, a set of abstract primitives. The abstract primitives are portions of data of abstract data types. Each abstract primitive is therefore a portion of data defined by its behavior in forms such as, but not limited to, possible values, possible operations which may be performed on the abstract primitive, possible behaviors of the operations which may be performed on the abstract primitive, a combination thereof, and the like. Such a portion of data having an abstract data type may be defined by the set of data included in the abstract data type data and a set of operations to be performed on the set of data.

At runtime, these abstract primitives are made concrete based on a target computing environment (for example, the computing environment in which the in-flight code is executed). To this end, the abstract primitives may be defined so that they can be implemented by different services and that, when implemented using different services, the services may utilize the abstract primitives to create applicable concrete definitions by matching the behavior-based definitions of the abstract primitives to components within the computing environment.

More specifically, the lift qualification data is generated based on the pre-flight objects indicated in pre-flight code as well as the corresponding in-flight objects for those pre-flight objects such that, when the lift qualification data is used to compile code, the resulting in-flight code generated via such compiling can resolve in-flight expressions to the applicable in-flight objects corresponding to the pre-flight objects in corresponding expressions among the pre-flight code.

To this end, in an embodiment, each pre-flight object and the corresponding in-flight object may be assigned the same identifier, and that identifier may be included among the lift qualification data in order to allow for resolving in-flight expressions to the corresponding object indicated among in-flight expressions. That is, a reference to an identifier which is shared by a pre-flight object and its counterpart in-flight object may effectively act as a reference to both the pre-flight and in-flight versions of the object. In this regard, the resulting in-flight code effectively resolves in-flight expressions to the appropriate pre-flight objects.

Optionally, the lift qualification data may include data disabling certain compilation errors. Such data may instruct a compiler which compiles code based on the lift qualification data to ignore or otherwise disable detection or output of such errors.

In some embodiments, the lift qualification data is generated based further on a reaching definitions data flow analysis of parameters passed to calls as indicated in the code. More specifically, in addition to using reaching definitions analysis in order to determine potential values for purposes of identifying in-flight expressions which resolve to pre-flight objects, reaching definitions analysis may also be applied to different parameters passed to calls in order to create more detailed lift qualifications. As a non-limiting example, when the reaching definitions analysis yields calls that ultimately involve accessing data requiring certain access permissions, the qualification data may include permissions needed to access that data.

In some embodiments, the phase-independent portions may be explicitly annotated as being flight-agnostic, and these annotations may be utilized to determine that supporting data for that portion of code may be shared between pre-flight and in-flight activities. To this end, in such an embodiment, the qualification data may include such annotations, and generating the qualification data includes generating the annotations, for example, using predetermined strings or other text indicating that portions of code are flight-agnostic or otherwise phase-independent.

At S370, lift instructions are generated. The lift instructions include instructions to be used during compiling in order to effectively lift pre-flight code for use in-flight. That is, the lift instructions are used during compiling in order to adapt the pre-flight code for in-flight activity. To this end, in an embodiment, the lift instructions include instructions corresponding to one or more portions of code (for example, one or more code blocks). The lift instructions for such portions of code may be generated using a language syntax adapted to enable lifting. More specifically, in an embodiment, the lift instructions are generated in order to effectively lift expressions representing in-flight operations being performed on pre-flight objects such that the lifted versions of those expressions in resulting compiled code resolve to the counterpart in-flight objects for those pre-flight objects. In a further embodiment, the lift instructions are generated based on the shared identifiers assigned to both pre-flight objects and their in-flight object counterparts.

More specifically, the language syntax may be designed to add explicit qualifications that link pre-flight objects to their in-flight object counterparts. To this end, the language syntax may have a structure corresponding to a structure used or otherwise capable of being accurately compiled by a compiler such that, when the compiler compiles code based on the lift instructions, compiler errors due to differences in formatting may be avoided. More specifically, the structure of the language syntax may enable the compiler to detect explicit lift portions of code along with variables and expressions, and to collect the data for a given explicit lift portion of code into a data structure assigned to each in-flight operation. The explicit qualifications may be defined based on user inputs in order to enable users to explicitly define at least some of the qualifications to be included among the lift instructions.

As noted above, executing the lifted code may include accessing or otherwise utilizing applicable in-flight libraries or other data used in-flight. To this end, in an embodiment, the lift instructions include instructions invoking classes that, when executed by a system, configure the system to synthesize these libraries or other data.

The qualifications may be or may include, but are not limited to, methods or other portions of code to be called at runtime in order to enable in-flight activities for the respective in-flight objects. To this end, these methods or other portions of code may be realized via a name (for example, a method name) and a set of rules defining arguments to that method (for example, defining certain types of inputs such as a regular expression). The qualifications may be defined with respect to shared identifiers associated with both each pre-flight object and the counterpart in-flight object such that the qualifications effectively identify both pre-flight objects and their counterpart in-flight objects. The qualifications, in turn, allow the lift instructions to translate between pre-flight objects and their counterpart in-flight objects. Multiple qualifications may be assigned to the same object represented in code to be lifted.

As a non-limiting example, the lift instructions may include instructions of an explicit lift block. The explicit lift block is a block of code that, when executed by a system, configures the system to add qualifications to pre-flight objects.

As noted above, in some embodiments, the qualification data may include annotations explicitly indicating certain portions of code as being phase-independent. In such embodiments, the lift instructions may include instructions for identifying and interpreting such annotations as well as for processing portions of code identified as being phase-independent in this manner.

FIG. 4 is a flowchart S270 illustrating a method for compiling code according to an embodiment.

At S410, data to be used for compiling into in-flight code is identified. In an embodiment, the data to be used for compiling includes data defined based on a set of lifted code for which lift instructions have been generated, for example as discussed above with respect to FIG. 3. The data to be used for compiling may include such lift instructions. More specifically, the lift instructions provide instructions for compiling the code into a lifted state such that the compiled code, when executed at runtime, seamlessly applies in-flight operations to pre-flight objects.

At S420, a target language for the compiling is identified. The target language may be a language used or otherwise recognized by a computing environment in which the compiled code is to be deployed, for example a target language selected as described above with respect to FIG. 2.

At S430, a configuration is determined based on the set of lift instructions included among the data to be used for compiling. As noted above, the lift instructions may define configurations for infrastructure components defined or otherwise referenced in code.

At S440, code types are identified for portions of code represented for the data to be used for compiling. In an embodiment, the identified code types include at least pre-flight code and in-flight code. In a further embodiment, the identified code types further include phase-independent code. The types of different portions of code may be identified based on the lift instructions, for example, by identifying portions of the code indicated in the lift instructions as being in-flight or phase-independent, and identifying any other portions of the code which are not indicated as being in-flight or phase-independent as being pre-flight.

At S450, an in-flight implementation file is generated using the lift instructions. As noted above, the lift instructions may define libraries or other data to be utilized for in-flight activities. The in-flight implementation file may be utilized in such libraries or other data, and may be referenced in the compiled code in order to access the file and, consequently, any libraries or other data contained therein.

At S460, one or more client libraries are generated and added to the in-flight implementation file. In an embodiment, the client libraries are generated using the lift instructions, that is, based on library definitions among the qualification data of the lift instructions.

At S470, one or more dependencies are injected into the data to be used for compiling the code. More specifically, the injected dependencies may be or may include dependencies on in-flight objects of the lifted code. To this end, the dependencies may be injected based on the lift instructions. As noted above, the lift instructions may indicate shared identifiers of objects referenced by in-flight operations in order to represent connections between pre-flight objects and their in-flight counterparts. These shared identifiers may be included in the lift instructions in order to indicate which objects are represented in in-flight portions of code. In an embodiment, the injected dependencies are dependencies referencing these shared identifiers and, in particular, the shared identifier for the pre-flight object referenced in each portion of code is injected as a dependency for that portion of code.

At S480, in-flight code is compiled using the data to be compiled and any additional data provided at any of S420 through S470. The result is a set of in-flight code that, when executed, is able to interact with in-flight objects corresponding to respective pre-flight objects, where the in-flight code is created based on a set of pre-flight code defining or otherwise identifying those pre-flight objects. That is, the resulting in-flight code is able to act upon in-flight objects as if they were the corresponding pre-flight objects. As noted herein, the in-flight objects may be defined as corresponding to counterpart pre-flight objects in order to facilitate translating code referencing pre-flight objects into code referencing their counterpart in-flight objects.

FIG. 5 is a flowchart 500 illustrating a method for executing in-flight code according to an embodiment. In an embodiment, the method is performed by a cloud server such as, but not limited to, one of the cloud servers 111, FIGS. 1A-B.

At S510, code to be executed is received. The code to be executed may be received, for example, from a code manager such as, but not limited to, the code manager 121 of FIG. 1A or the code manager 131 of FIG. 1B. In an embodiment, the code to be executed is a set of compiled code generated based on using lift instructions as discussed above. In an embodiment, the code includes one or more pre-flight portions defining infrastructure components and one or more in-flight portions which act upon such infrastructure components.

The code may further include one or more phase-independent portions which lack reference to any infrastructure components (for example, which neither define an infrastructure component to be created via a pre-flight operation or references an infrastructure to be acted upon via an in-flight operation. In this regard, the phase-independent portions may act as flight-agnostic code which may be utilized for either pre-flight or in-flight activities in its current state (for example, without lifting the code using lift qualifications and lift instructions or otherwise modifying those portions of code). In some embodiments, the phase-independent portions may be explicitly annotated as being flight-agnostic, and these annotations may be utilized to determine that supporting data for that portion of code may be shared between pre-flight and in-flight activities.

As discussed above, the code is lifted such that lift qualification data is utilized with respect to any in-flight portions of the code in order to facilitate references between in-flight objects and their pre-flight counterparts. The code, when executed, utilizes the lift qualification data to leverage applicable APIs for pre-flight and in-flight activities (for example, using pre-flight APIs and in-flight APIs, respectively). The lift qualification data may therefore allow for using pre-flight definitions to generate infrastructure components and adding shared identifiers to the resulting infrastructure components such that in-flight portions of code written or otherwise generated pre-flight can seamlessly interact with infrastructure components created at runtime based on definitions established pre-runtime.

At S520, the code is loaded into a memory for execution, thereby beginning execution.

At S530, a class is instantiated by executing at least a portion of the code. As noted above, lift instructions used to compile the code may include classes that, when executed, cause synthesis of libraries or other data to be used at runtime. Accordingly, by instantiating these classes, the libraries may be synthesized for subsequent use.

At optional S540, one or more configuration inputs are received. The configuration inputs may be received, for example, as user inputs, and may be used to modify a configuration of the software infrastructure being managed via the executed code. The configuration inputs may be used to further customize a configuration of a software infrastructure in-flight at runtime on top of any configurations defined pre-flight.

At S550, a configuration is set based on the configuration inputs and the code being executed.

At S560, one or more in-flight operations are performed. In an embodiment, performing the in-flight operations includes using any in-flight APIs assigned to in-flight operations as defined in the code being executed. At least some of the in-flight operations may reference or otherwise indicate pre-flight objects. In accordance with various disclosed embodiments, the lift instructions used for generating the compiled code may define shared identifiers for in-flight objects which are shared with their pre-flight object counterparts. The compiled code may include these identifiers such that references to pre-flight objects in the in-flight code may be effectively translated into the in-flight counterparts of those pre-flight objects created at runtime.

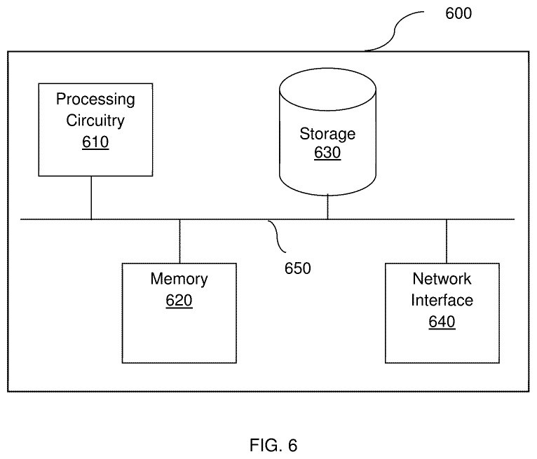

FIG. 6 is an example schematic diagram of a hardware layer 600 which may be utilized to realize a code manager (for example, the code manager 121 or the code manager 131 of FIG. 1A or FIG. 1B, respectively) according to an embodiment. The hardware layer 600 includes a processing circuitry 610 coupled to a memory 620, a storage 630, and a network interface 640. In an embodiment, the components of the hardware layer 600 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (for example, random access memory, etc.), non-volatile (for example, read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (for example, in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the hardware layer 600 to communicate with other systems, devices, components, applications, or other hardware or software components, for example as described herein.

It should be understood that the embodiments described herein are not limited to the specific architecture illustrated in FIG. 6, and other architectures may be equally used without departing from the scope of the disclosed embodiments.

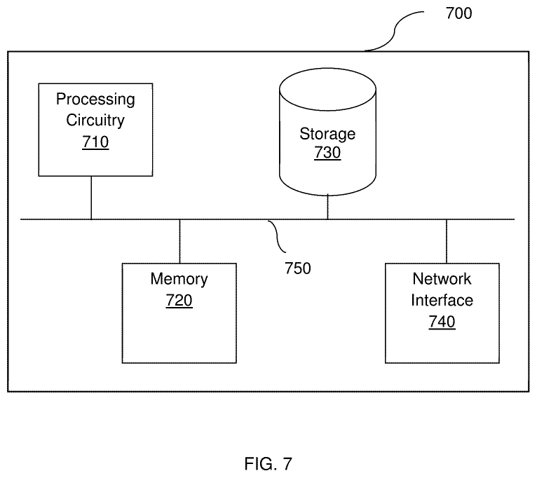

FIG. 7 is an example schematic diagram of a hardware layer 700 which may be utilized to realize one or more cloud servers (for example, the cloud server 111, FIGS. 1A-B) according to an embodiment. The hardware layer 600 includes a processing circuitry 710 coupled to a memory 720, a storage 730, and a network interface 740. In an embodiment, the components of the hardware layer 700 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (for example, random access memory, etc.), non-volatile (for example, read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (for example, in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the hardware layer 700 to communicate with other systems, devices, components, applications, or other hardware or software components, for example as described herein.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for compiling code, comprising:
analyzing at least one portion of code among a first set of code in order to determine a plurality of potential values for each of the at least one portion of code, wherein analyzing the at least one portion of code further comprises performing a reaching definitions data flow analysis on the at least one portion of code;
identifying a plurality of runtime calls to a plurality of first software infrastructure components in the first set of code based on the determined plurality of potential values for each of the at least one portion of code, wherein each runtime call of the plurality of runtime calls is to be made at runtime;
generating lift qualification data based on the plurality of runtime calls to the plurality of first software infrastructure components, wherein the set of lift qualification data includes a method name and a set of rules, wherein the method name corresponds to a method which is configured to translate an indicator of a first software infrastructure component among the plurality of first software components to an indicator of a second software infrastructure component of a plurality of second software components, wherein each second software component is defined at runtime and corresponds to one of the plurality of first software components, wherein the set of rules defines configuration parameters and permissions to be used for applying the plurality of runtime calls to the plurality of first software infrastructure components; and
compiling a second set of code based on the lift qualification data.

2. The method of claim 1, further comprising:
generating a set of lift instructions based on the lift qualification data, wherein the set of lift instructions, when executed by a system while compiling the second set of code, configures the system to execute the method corresponding to the method name indicated in the set of lift qualification data.

3. The method of claim 1, wherein each first software component and the corresponding second software component are both assigned a shared identifier of a plurality of shared identifiers, wherein the lift qualification data is generated based on the plurality of shared identifiers.

4. The method of claim 3, further comprising:
aggregating at least a portion of the plurality of calls based on a plurality of references in the first set of code to the plurality of first software infrastructure components and the plurality of shared identifiers, wherein the lift qualification data is generated based further on the aggregation.

5. The method of claim 1, further comprising:
assigning at least one first application programming interface (API) to each of the plurality of first software infrastructure components, wherein each first API is utilized to configure at least a portion of a software infrastructure; and
assigning at least one second API to each of the plurality of second software infrastructure components, wherein each second API is utilized to access at least one resource at runtime, wherein the lift qualification data is generated based on the at least one first API assigned to each of the plurality of first software infrastructure components and the at least one second API to each of the plurality of first software infrastructure components.

6. The method of claim 1, wherein analyzing the at least one portion of code further comprises:
determining a plurality of expressions which evaluate to first software infrastructure components of the plurality of first software infrastructure components, wherein the plurality of runtime calls to the plurality of first software infrastructure components is identified based on the determined plurality of expressions.

7. The method of claim 1, wherein analyzing the at least one portion of code further comprises:
iteratively checking potential values of the plurality of potential values for each of the plurality of runtime calls, wherein the potential values are iteratively checked for each runtime call until all potential values for the runtime call evaluate to one of the plurality of first software infrastructure components.

8. The method of claim 1, further comprising:
selecting a target language based on a computing environment in which the second set of code is to be deployed, wherein the second set of code is compiled based on the target language.

9. The method of claim 1, further comprising:
identifying at least one phase-independent portion of code among the first set of code, wherein each phase-independent portion of code lacks reference to any of the plurality of first software infrastructure components, wherein the lift qualification data is generated based further on the identified at least one phase-independent portion of code.

10. A non-transitory computer readable medium having stored thereon instructions for causing a processing circuitry to execute a process, the process comprising:
analyzing at least one portion of code among a first set of code in order to determine a plurality of potential values for each of the at least one portion of code, wherein analyzing the at least one portion of code further comprises performing a reaching definitions data flow analysis on the at least one portion of code;
identifying a plurality of runtime calls to a plurality of first software infrastructure components in the first set of code based on the determined plurality of potential values for each of the at least one portion of code, wherein each runtime call of the plurality of runtime calls is to be made at runtime;
generating lift qualification data based on the plurality of runtime calls to the plurality of first software infrastructure components, wherein the set of lift qualification data includes a method name and a set of rules, wherein the method name corresponds to a method which is configured to translate an indicator of a first software infrastructure component among the plurality of first software components to an indicator of a second software infrastructure component of a plurality of second software components, wherein each second software component is defined at runtime and corresponds to one of the plurality of first software components, wherein the set of rules defines configuration parameters and permissions to be used for applying the plurality of runtime calls to the plurality of first software infrastructure components; and
compiling a second set of code based on the lift qualification data.

11. A system for compiling code, comprising:
a processing circuitry; and
a memory, the memory containing instructions that, when executed by the processing circuitry, configure the system to:
analyze at least one portion of code among a first set of code in order to determine a plurality of potential values for each of the at least one portion of code, wherein analyzing the at least one portion of code further comprises performing a reaching definitions data flow analysis on the at least one portion of code;
identify a plurality of runtime calls to a plurality of first software infrastructure components in the first set of code based on the determined plurality of potential values for each of the at least one portion of code, wherein each runtime call of the plurality of runtime calls is to be made at runtime;
generate lift qualification data based on the plurality of runtime calls to the plurality of first software infrastructure components, wherein the set of lift qualification data includes a method name and a set of rules, wherein the method name corresponds to a method which is configured to translate an indicator of a first software infrastructure component among the plurality of first software components to an indicator of a second software infrastructure component of a plurality of second software components, wherein each second software component is defined at runtime and corresponds to one of the plurality of first software components, wherein the set of rules defines configuration parameters and permissions to be used for applying the plurality of runtime calls to the plurality of first software infrastructure components; and
compile a second set of code based on the lift qualification data.

12. The system of claim 11, wherein the system is further configured to:
generate a set of lift instructions based on the lift qualification data, wherein the set of lift instructions, when executed by a system while compiling the second set of code, configures the system to execute the method corresponding to the method name indicated in the set of lift qualification data.

13. The system of claim 11, wherein each first software component and the corresponding second software component are both assigned a shared identifier of a plurality of shared identifiers, wherein the lift qualification data is generated based on the plurality of shared identifiers.

14. The system of claim 13, wherein the system is further configured to:
aggregate at least a portion of the plurality of calls based on a plurality of references in the first set of code to the plurality of first software infrastructure components and the plurality of shared identifiers, wherein the lift qualification data is generated based further on the aggregation.

15. The system of claim 11, wherein the system is further configured to:
assign at least one first application programming interface (API) to each of the plurality of first software infrastructure components, wherein each first API is utilized to configure at least a portion of a software infrastructure; and
assign at least one second API to each of the plurality of second software infrastructure components, wherein each second API is utilized to access at least one resource at runtime, wherein the lift qualification data is generated based on the at least one first API assigned to each of the plurality of first software infrastructure components and the at least one second API to each of the plurality of first software infrastructure components.

16. The system of claim 11, wherein the system is further configured to:
determine a plurality of expressions which evaluate to first software infrastructure components of the plurality of first software infrastructure components, wherein the plurality of runtime calls to the plurality of first software infrastructure components is identified based on the determined plurality of expressions.

17. The system of claim 11, wherein the system is further configured to:
iteratively check potential values of the plurality of potential values for each of the plurality of runtime calls, wherein the potential values are iteratively checked for each runtime call until all potential values for the runtime call evaluate to one of the plurality of first software infrastructure components.

18. The system of claim 11, wherein the system is further configured to:
select a target language based on a computing environment in which the second set of code is to be deployed, wherein the second set of code is compiled based on the target language.

19. The system of claim 11, wherein the system is further configured to:
identify at least one phase-independent portion of code among the first set of code, wherein each phase-independent portion of code lacks reference to any of the plurality of first software infrastructure components, wherein the lift qualification data is generated based further on the identified at least one phase-independent portion of code.
